(19) United States
(12) Patent Application Publication
(10) Pub. No.: US 2019/0263036 A1
(43) Pub. Date: Aug. 29, 2019

(54) COMPONENT COMPRISING A COVER LAYER AND METHOD FOR PRODUCING A COMPONENT OF THIS KIND

(71) Applicant: WEIDPLAS GmbH, Kusnacht (CH)

(72) Inventors: Marcel STOSSEL, Kaltbrunn (CH); Daniel SCHELTER, Lachen (CH); Steffen REUTER, Uerikon (CH); Jonas KIRCHNER, Meilen (CH); Christoph GSELL, Rapperswil (CH); Jan-Eric FRIJTERS, Oberiberg (CH)

(73) Assignee: WEIDPLAS GmbH, Kusnacht (CH)

(21) Appl. No.: 16/461,068

(22) PCT Filed: Nov. 21, 2017
(86) PCT No.: PCT/EP2017/079892

§ 371 Date: May 15, 2019

(30) Foreign Application Priority Data
Dec. 9, 2016 (EP) 16203245.2

(51) Int. Cl. B29C 45/16

(52) U.S. Cl. CPC B29C 45/1679; B29K 2105/0094; B29C 2045/167

(57) ABSTRACT

The invention discloses a method for producing a component having a base element (1), which has a front side (10) delimited by an outer edge (11), a rear side (14) and one or more side surfaces (15) that connect the front side (10) to the rear side (14). The component also has a cover layer (2) formed of a coating, said layer being sprayed onto the base element (1), wherein during spraying, the coating is guided through one or more supply channels (16), which extend continuously through the base element (1) to the front side (10) and/or to one or more side surfaces (15). During spraying, the coating is flooded onto at least part of the side surfaces (15).

### TECHNICAL FIELD

The present invention relates to a method for producing a component with a base element and with a cover layer which is injection molded thereon and formed from a lacquer. The present invention also relates to a component which is produced according to such a method.

### PRIOR ART

Components with a base element and cover layer which is injection molded onto its front side are known in particular in the automobile industry in the form of decorative trim strips or door sill panels, for example. By a cover layer being injection molded onto the front side of the base element, a variety of visual effects can be achieved with regard to the finished component.

For example, the international application WO 2016/193384 A1 filed by the same applicant discloses a component with two cover layers, injection molded onto a decorative element, which together with a region of the decorative element form a visible side of the component.

Particularly when the cover layer is a lacquer, which is usually thin-bodied and forms for example a highly polished coating, there is the problem that the injection point(s) or gate marks remain visible on the finished component. This can be prevented if the part with the injection point is cut off after the injection molding process. In this case, however, the separation surface remains visible. Moreover, such a method can only be used to a limited extent and only on components with comparatively small visible surfaces since otherwise the lacquer can already be hardened when flowing over. The production of a cover layer in an injection molding process is to be in such a way that the cover layer has no manufacture-related irregularities in the region of its visible surface, which in any case constitutes a challenge.

In DE 10 2013 016 230, it is proposed to provide a feed channel in an element which is produced from a first plastic component in order to direct a second plastic component through this during the injection molding into a recess formed on the front side of the element. The injection point is consequently located on a side of the component facing away from the observer, and the second component forms an aesthetically attractive, regular visible surface inside the recess. The visible surface which is formed by the second plastic component, however, is limited to a region which is located inside the front side of the first component.

DE 697 12 685 also discloses a method for producing a multilayer object in which a thermoplastic resin is directed through a hole, which is formed in a first layer, in order to flood over from there the front side of the first layer and to form a second layer.

### SUMMARY OF THE INVENTION

It is an object of the present invention to specify a method which enables a versatile design of the visible surface of a component by means of an aesthetically attractive cover layer formed from a lacquer.

For achieving this object, a method is proposed as is specified in claim 1. Also, a component which is produced according to such a method is specified in claim 19. Advantageous embodiments of the invention are specified in the dependent claims.

The present invention therefore provides a method for producing a component with a base element which has a front side delimited by an outer rim, a rear side and also one or more side surfaces which interconnect the front side and the rear side, and with a cover layer, formed from a lacquer, which is injection molded onto the base element, in particular onto at least a part of its front side, wherein the lacquer, during the injection molding, is directed through one or more feed channels which extend in particular from the rear side of the base element continuously through the base element toward the front side and/or toward one or more of the side surfaces. During the injection molding, the lacquer is flooded onto at least a part of the side surfaces in the process.

By the lacquer being flooded onto at least a part of the side surfaces, adaptable design possibilities are created, in particular in the case of such components in which not only the surface which directly faces the front but also side surfaces are visible by the observer. By means of a corresponding number and arrangement of the feed channel(s), a widely extended surface can also be covered with a comparatively thin cover layer since the lacquer reaches all regions of the surface during the injection molding within a shorter time and before hardening. As a result of feeding the lacquer from the rear side of the base element through the feed channel(s), the component can, moreover, be produced in such a way that on the visible surface which is formed by the cover layer no injection points or other manufacture-related irregularities are visible. Compared with this, with the method of the prior art either the design possibilities are substantially limited or from the aesthetic point of view disadvantages need to be taking into consideration if the cover layer is to extend not only over the front side but also over the side surfaces of the base element.

The lacquer, during the injection molding, is preferably flooded over and beyond the rim of the front side, for example from the front side onto at least a part of the side surfaces, or from at least a part of the side surfaces onto the front side. In particular, the lacquer, during the injection molding, is preferably directed through one or more feed channels which extend continuously through the base element toward the front side and floods over and beyond the rim of the front side onto at least a part of the side surfaces. In the case of this particularly preferred embodiment, the lacquer advantageously first of all floods over at least a part of the front side, then over the rim and finally over at least a part of the side surfaces. In most of the embodiments, a simpler production of the feed channel(s) is created as a result.

The component preferably forms a decorative element. It is preferably intended for the automobile industry, moreover, and in particular as a door sill panel or decorative trim strip.

The base element is preferably produced from plastic. It is advantageously produced, moreover, as a whole in one piece and in particular advantageously produced in an injection molding process. If the base element is produced in an injection molding process, the feed channel(s) is/are advantageously already formed during the injection molding, for example by means of projections correspondingly provided in the injection mold. Alternatively, the feed channel(s) can for example also be formed by means of etching, stamping, lasering or drilling. The base element preferably forms an essentially rigid, self-supporting structure.

The outer rim of the front side of the base element is preferably formed by a front edge at which the front side and the side surface meet each other. At the front edge, the front side and the corresponding side surface in each case preferably include an angle of less than 180° up to about 90°, preferably from 150° to about 90°. The front edge and/or the side surface(s) can in this case be of rounded design, wherein it is advantageously clearly evident, however, where the outer rim, in which the front side merges into the side surface, is approximately located. The side surface, or side surfaces, advantageously has/have in each case at least one section which extends perpendicularly to at least one section of the front side. Advantageously, a predominantly large part of the front side, that is to say more than 50% of the surface formed by the front side, is essentially of planar design, and preferably also a predominantly large part of the side surface(s) is essentially of planar design. In particular advantageously, even the entire front side of the base element essentially forms a surface of essentially planar design. The side surfaces of the base element in particular preferably also form overall in each case a surface of essentially planar design. The base element overall preferably has an essentially cuboid shape which in the directions perpendicular to the side surfaces has substantially larger dimensions, that is to say preferably by a multiple, than in the direction perpendicular to the front side and to the rear side. The base element can in principle have any design.

The feed channel(s) therefore completely penetrates/penetrate the base element, that is to say they each have a first mouth which is arranged inside the front side and/or the side surface(s), from which the lacquer, during the injection molding, floods over at least a part of the side surfaces and preferably even over at least a part of the front side. The feed channel(s) also has/have a second mouth which is preferably arranged inside the rear side. The second mouth, however, can also be arranged inside one of the side surfaces if the first mouth is arranged inside the front side. The design of the feed channel(s) is advantageously of tubular or cylindrical shape.

In the case of the lacquer, it can be a single-component (1C) lacquer or a two-component (2C) lacquer. If it is a 2C-lacquer, it is preferably a polyurea lacquer (PUA) with a first component made of polyamine and a second component made of (di-) isocyanate. Similarly, the 2C-lacquer can preferably be a polyurethane lacquer (PUR) with a first component made of polyol and a second component made of (di-)isocyanate. If it is a 1C-lacquer, it is preferably a polyurethane-prepolymer.

The lacquer, preferably at the point in time at which the lacquer begins to harden, advantageously has a viscosity in the range of between 40 mPa*s and 500 mPa*s, measured at 65° C. In the case of a two-component lacquer, the point in time at which the lacquer begins to harden is preferably the point in time directly after the components of the lacquer have been intermixed. With such viscosity values, good flowability of the lacquer is ensured. The viscosity is advantageously measured according to DIN 53019-1 Standard, September 2008 edition. The measuring of the viscosity is preferably carried out using a cone and plate rotational viscometer which has a fixed measuring cup and a rotating measuring body.

The base element preferably has at least one rear edge of in particular encompassing form in which the rear side and the side surface or the side surfaces meet each other. At this rear edge, the rear side and the corresponding side surface preferably each include an angle of more than 0° to about 90°, preferably from 45° to about 90°. This rear edge can be of rounded design in this case, wherein it is advantageously clearly evident, however, where the rear side and the respective side surface approximately meet each other. A predominantly large part of the rear side is advantageously of essentially planar design. In particular, even the entire rear side of the base element advantageously forms essentially a surface of essentially planar design.

In an in particular preferred embodiment, the lacquer, during the injection molding, floods over at least a part of the side surfaces up to the rear edge. The cover layer consequently completely covers the corresponding part of the side surfaces from the front side up to the rear edge. This has the advantage that the observer, even if he/she looks at the component from a side direction, sees a cover layer which extends continuously over the side surface(s) and up to the rear edge. The base element is completely covered by the cover layer in the corresponding regions and, if this is formed opaquely, is not visible.

During the injection molding, the lacquer can flood completely over both the front side and the side surface, or the side surfaces, in each case. That is to say, the side surface(s) is/are each completely flooded over from the front edge up to the rear edge. With the component finished and installed as intended, the base element from the observer's perspective is then preferably completely covered by the cover layer and, if this is formed opaquely, is not visible at any point and from any direction of view, not even in the region of the rear edge. By means of the method according to the invention, a continuously aesthetically attractive lacquer surface without irregularities is still possible. The rear side of the base element then usually lies on an installation surface and is consequently not visible for the observer.

According to one development of the invention, a plurality of feed channels each have an opening, wherein the largest possible inner circle of a respective opening has a diameter of between 0.2 and 5 mm, preferably between 1 and 5 mm. Openings with this diameter allow an optimum injection passage of the lacquer through the base element and can be produced in a simple manner. The use of a lacquer in contrast to another substance, such as conventional plastic, such as thermoplastic, for example, for producing the cover layer enables small dimensioning of the feed channels in this way since the lacquer customarily has a much lower viscosity than melts of conventional plastics. Preferably, the openings are of circular design, preferably designed as a circle, preferably in plan view of the base element. Openings having such a shape can be produced in a particularly simple manner. According to a further preferred embodiment, the openings are designed as a polygon, such as a triangle or quadrangle, preferably in plan view of the base element. By means of openings having such a shape, specific light effects can be achieved. Preferably, a feed channel which is associated with a respective opening has a cross section which essentially is identical to the shape of the respective opening.

According to one development of the invention, the cover layer has a thickness of between 0.3 and 1.5 mm. The cover layer is advantageously produced in an injection molding process by means of an injection mold. By using lacquer, cover layers can be produced in an injection molding process with such small thicknesses and therefore inexpensively. Furthermore, by using lacquer a complete filling of the cavity of the injection mold which is to be filled with lacquer can be achieved. This is particularly important in the case of production of components with visible surfaces of large dimensions.

According to one development of the invention, a plurality of feed channels each have an opening, wherein the largest possible inner circle of a respective opening has a diameter of between 0.2 and 5 mm, preferably of between 1 and 5 mm, wherein the cover layer has a thickness of between 0.3 and 1.5 mm, and wherein the cover layer is preferably produced in an injection molding process by means of an injection mold. This development of the invention allows an inexpensive and optimum production of the component in any dimensions.

The base element is advantageously produced in a first injection mold and the cover layer is produced in a second injection mold. The base element is therefore removed from the first injection mold after its production and inserted in a second injection mold for producing the cover layer.

According to one development of the invention, the cover layer is at least partially translucent, that is to say is at least partially penetrable by light. The cover layer can even be at least partially transparent, that is to say have see-through effect. Preferably, it is translucent, in particular transparent, at least in the regions of the feed channels. More preferably, it is totally, in other words in all regions, translucent, in particular transparent.

At least one lighting element can be provided which advantageously forms an element of the component. The lighting element preferably serves for the purpose of illuminating the component through the feed channel(s). On account of the transparently or translucently formed lacquer, which in this case is arranged inside the feed channels, and the cover layer, which is preferably also formed from the transparent or translucent lacquer arranged inside the feed channels, the light radiated by the lighting element can make its way through the feed channels and the cover layer to the observer of the component. The feed channels therefore serve not only for the injection molding of the cover layer during production but also serve as light conducting channels for the passage of light in the finished component. The lighting through the feed channels lends a specific visual effect to the component and as a result increases its distinguishability. The lighting element is preferably at least partially, preferably completely, arranged inside the base element. This provides the advantage that the lighting element is protected against external influences. The lighting element is preferably arranged inside the base element in such a way that the lighting element can couple light directly into the light conducting channel. This embodiment is in particular then used if the base element is produced from an opaque material.

The cover layer, if it is of transparent of translucent design, advantageously forms a diffuser. On account of the diffuser effect, the light which is directed through the cover layer is scattered and distributed in this. As a result, a light radiation which is uniformly distributed over the entire cover layer can in particular be achieved.

According to one development of the invention, the base element is produced from an opaque material, preferably from opaque plastic. The term “opaque” means “impervious by light”.

According to one development of the invention, the base element is produced from a translucent, preferably transparent material, in particular plastic. Preferably, the material which is arranged in the feed channels is also of translucent, preferably transparent, design and the cover layer is also produced from a translucent, preferably transparent, material. According to a first variant, the material from which the base element is produced is less light conductive compared with the material which is arranged in the feed channels and/or the material from which the base element is produced is less light conductive compared with the material from which the cover layer is produced. According to a second variant, the material from which the base element is produced is more light conductive compared with the material which is arranged in the feed channels and/or the material from which the base element is produced is more light conductive compared with the material from which the cover layer is produced. The term “less light conductive” means that light is not conducted as easily. Correspondingly, the term “more light conductive” means that light is conducted better. By means of this development of the invention, a wide variety of light effects can be achieved.

If the cover layer is of translucent or transparent design, provision is advantageously made for a plurality of feed channels which each have an opening, wherein the largest possible inner circle of a respective opening has a diameter of between 0.2 and 5 mm, preferably between 1 and 5 mm, and wherein the center points of the inner circles have a mutual distance of at least 0.4 mm. This arrangement and dimensioning of the feed channels allows the injection molding of the cover layer through the feed channels to be possible without any problem and, moreover, to make it possible for the component to be adequately, in particular homogenously, illuminated through the feed channels. The injection molding of the cover layer through feed channels of such small dimensions is possible on account of the use of lacquer which has a comparatively low viscosity. If use is made of another substance, such as in particular conventional plastic, that is to say for example thermoplastic, this would not be possible since melts of conventional plastics usually have a much higher viscosity than lacquer.

The cover layer is advantageously produced in an injection molding process. During the injection of the lacquer, a projection which protrudes in relation to the rear side of the base element can be formed in each case in the region(s) of the feed channel(s). These projections are preferably formed on account of the injection channels, which are formed in the injection mold, through which the lacquer is fed during the injection molding. The projections can have an essentially cylindrical shape on account of the shape of the injection channels. The injection channels advantageously have a shape, however, which conically widens toward the base element, as a result of which removal of the component from the injection mold is made easier. In this case, the projection(s) also has/have a conical shape. After removal of the component from the injection mold the projection(s) can be separated from the component. According to one development of the invention, the projection(s), however, is/are at least partially left on the component. If the cover layer is of translucent or transparent design, it can then serve as a light conductor in order to conduct light toward the front side and/or side surface of the base element.

The component can have an add-on part which covers at least a part of the front side and/or side surface of the base element, and which during the injection molding is in contact with the lacquer and consequently is connected to the cover layer. In other words, the add-on part is retained on the base element by means of the cover layer after the injection molding process. The injection molding of the cover layer therefore serves at the same time for the fixing of the add-on part.

The add-on part can be arranged between the base element and the cover layer. The add-on part advantageously lies in this case directly on the front side and/or the side surface of the base element. The add-on part is therefore advantageously seated on the front side and/or the side surface of the base element before the injection molding. During the injection molding, the lacquer is then flooded over the add-on part in the region of the front side and/or the side surface of the base element so that this comes to lie between the lacquer, which forms the cover layer in the finished component, and the front side and/or the side surface of the base element. The base element advantageously has at least one forward projecting baffle wall in the region of the front side and/or side surface in order to protect the add-on part during the injection molding for example against slipping and/or against excessively high injection pressure.

According to one development of the invention, the feed channel(s) extends/extend through the add-on part so that the lacquer, during the injection molding, is directed through the add-on part toward the front side and/or the side surface of the base element. That means that the add-on part has one or more through-openings which open(s) into the feed channels which are formed on the base element so that the lacquer, during the injection molding, can make its way through the add-on part toward the front side of the add-on part and toward the front side and/or side surface of the base element. In this way, the add-on part can cover a comparatively large area of the front side and/or side surface of the base element and still be flooded over by the lacquer before this hardens. In the case of a transparent or translucent cover layer, moreover, lighting through the feed channel(s) can also be carried out, moreover, in the region of the add-on part.

In the case of the add-on part, it can in particular be a foil or an electronic unit. According to a first preferred embodiment, the foil, at least in certain regions, is preferably completely of translucent, preferably transparent, design. According to a second preferred embodiment, the foil, at least in certain regions, is of translucent, preferably completely opaque design. In the case of a foil, it can in particular be a colored foil in order to lend a corresponding color to the component if the cover layer is in particular of transparent or translucent design.

The cover layer can also be arranged between the base element and the add-on part. That is to say, the add-on part then advantageously lies directly on the side of the cover layer facing the observer. In this case, the add-on part can in particular be a foil which is preferably a protective foil which is preferably adapted to be removed from the component before the intended use of this. Such protective foils are generally known particularly in the case of lacquer and highly polished surfaces and serve for the protection of these surfaces before the intended use of the component. The foil is preferably already attached to the cover layer during the injection molding. The foil can be retained on the injection mold or on the base element for example with the aid of a vacuum before the injection molding. it can also adhere electrostatically on the injection mold or on the base element. In contrast to the prior art, where the protective foil is customarily attached to the component only after the finishing of this, this process step is therefore dispensed with in this case. By attaching the protective foil during the injection molding, the cover layer is already protected, moreover, against possible external influences when the component is being removed from the injection mold. Instead of being designed as a protective foil, the foil can also be designed as a decorative foil which is not removed from the finished and installed component.

According to one development of the invention, the front side and/or the side surface of the base element has/have local elevations and/or recesses. The elevations and/or recesses can serve for the purpose of improving the connection between the cover layer and the base element. They can also form a logo or a symbol which is visible on the component for the observer.

The present invention also relates to a component which is produced in the way specified above and correspondingly designed. The component, as also described above, has a base element with a front side, a rear side and with one or more side surfaces which interconnect the front side and the rear side, and also one or more feed channels which extend continuously through the base element toward the front side and/or toward one or more of the side surfaces. It also has a cover layer which covers at least a part of the side surface or of the plurality of side surfaces.

According to one development of the invention, the feed channel or at least one of the feed channels, preferably all the feed channels, is/are filled at least partially, preferably completely, with lacquer.

According to one development of the invention, the front side is at least partially, preferably completely, filled with lacquer and/or the side surface and the plurality of side surfaces is/are covered at least partially, preferably completely, with lacquer.

### BRIEF DESCRIPTION OF THE DRAWINGS

Preferred embodiments of the invention are described in the following text with reference to the drawings which serve purely for explanation and are not to be interpreted as being limiting. In the schematically represented drawings in each case:

FIG. 1 shows a suitable injection mold for use in the method according to the invention for producing the base element;

FIG. 2 shows the production of the base element in the injection mold of FIG. 1;

FIG. 3 shows the base element after its removal from the injection mold of FIG. 1;

FIG. 4 shows the production of a component according to the invention in a further injection mold;

FIG. 5 shows a plan view of the base element of a component according to the invention with the diameters and distances of the openings of the feed channels;

FIG. 6 shows a finished component according to one embodiment according to the invention;

FIG. 7 shows a finished component according to another embodiment according to the invention;

FIG. 8 shows a base element and also an electronic unit of component according to the invention according to another embodiment, before the injection molding of the cover layer;

FIG. 9 shows the base element and the electronic unit of FIG. 8 installed therein, with foil attached thereto, before the injection molding of the cover layer for producing a component according to a further embodiment;

FIG. 10 shows the base element, inserted in an injection mold, with electronic unit inserted therein and foil of FIG. 9 attached thereon, directly before the injection molding;

FIG. 11 shows the component, removed from the injection mold of FIG. 10, after the injection molding, which corresponds to a further embodiment according to the invention;

FIG. 12 shows the component of FIG. 11 after its installation and after removal of the protective foil; and

FIG. 13 shows a plan view of the component of FIG. 12.

### DESCRIPTION OF PREFERRED EMBODIMENTS

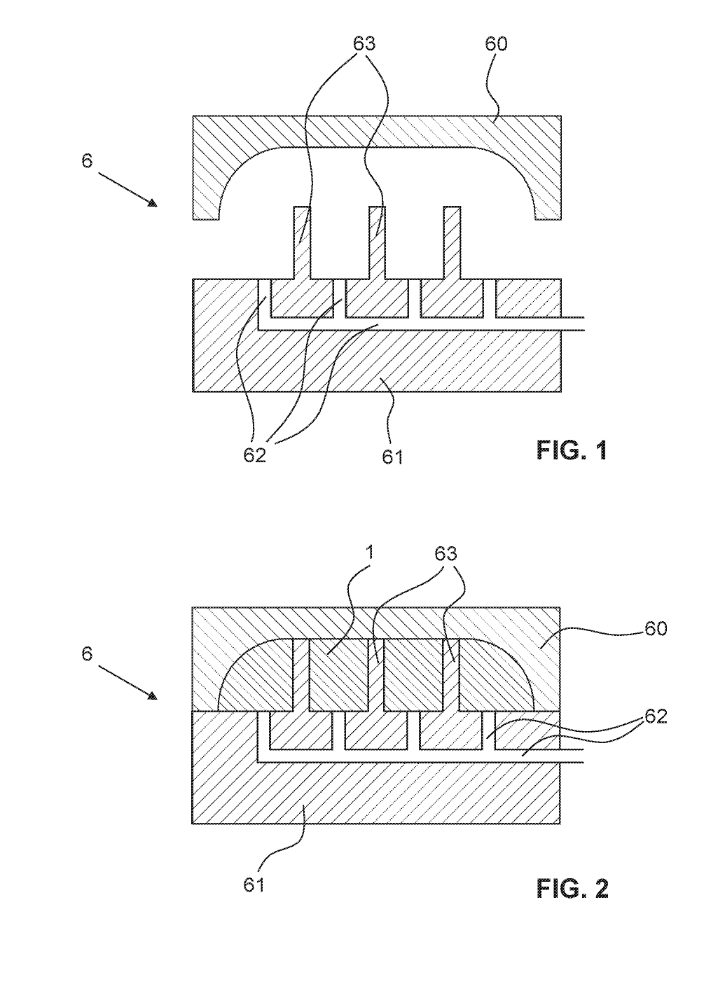

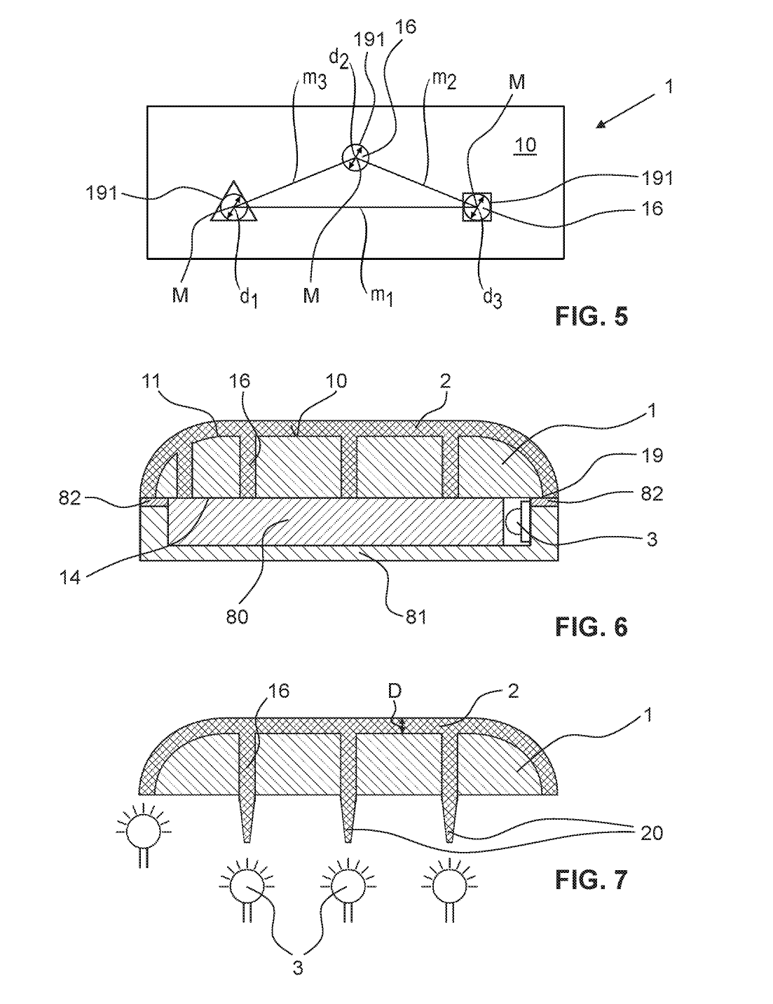

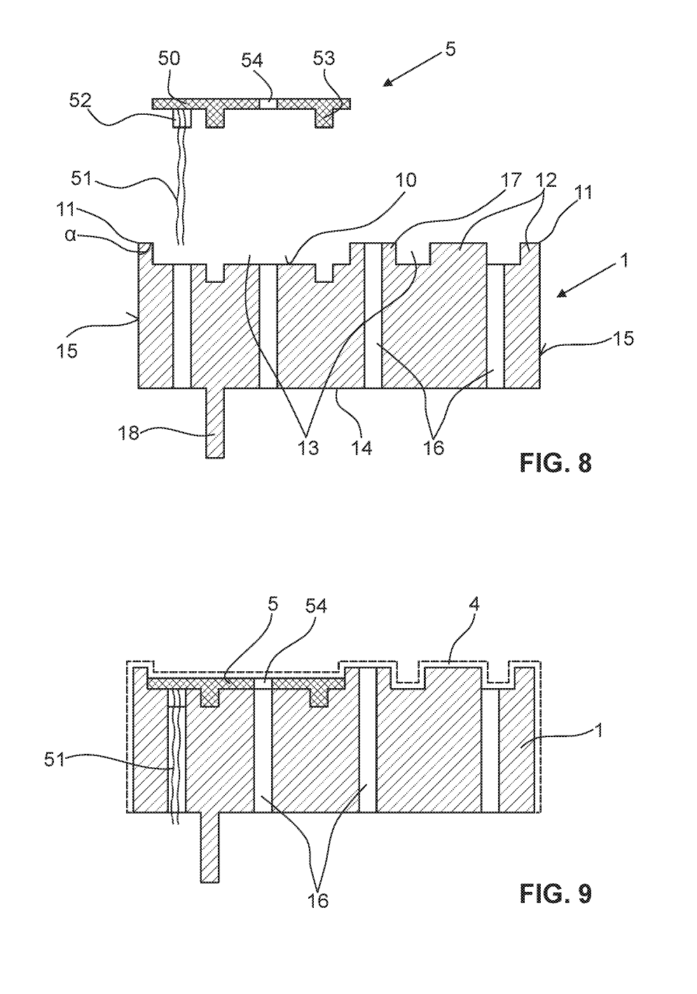

Shown in FIGS. 1 to 4 are the essential method steps of a method according to the invention for producing a component according to the invention. FIG. 5 illustrates a preferred embodiment of the base element 1 of a component according to the invention. Shown in FIGS. 6 and 7 are different embodiments of finished components according to the invention. FIGS. 8 to 10 illustrate essential method steps of another method according to the invention for producing another component according to the invention, as is shown in FIGS. 11-13. Elements with an identical or similar technical function and effect are provided in each case with the same reference numerals in FIGS. 1 to 13.

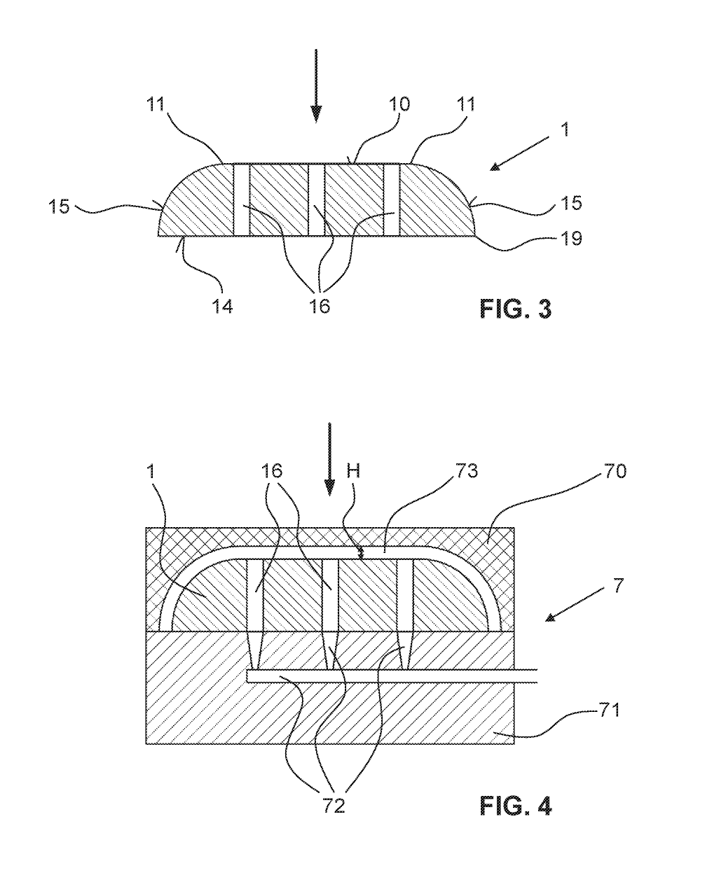

FIG. 1 shows an injection mold 6 which serves for producing a base element 1 of a component according to the invention. The finished base element 1 is shown in FIG. 3. The injection mold 6 has a first injection mold 60 and a second injection mold 61 which in accordance with FIG. 2 can be joined together in such a way that a cavity is formed therebetween in the desired shape of the base element 1.

The first injection mold 60 forms a front side 10 and the encompassing side surface 15 of the base element 1.

The second injection mold 61 forms a rear side 14 of the base element 1, which in this case is a planar design. The injection mold 61 also has a plurality of projections 63 which serve for forming teed channels 16 in the finished base element 1. The projections 63 are of cylindrical shape in each case and extend upward parallel to each other. In the closed state of the injection mold 6, the projections 63 butt against the first injection mold 60 by their end faces in each case, as is apparent from FIG. 2.

The second injection mold 61 also has injection channels 62 for injecting plastic into the cavity which is formed by the injection molds 60 and 61 in the closed state of the injection mold. The injection channels 62 are formed by a main channel and a plurality of end channels. The main channel branches in this case into the end channels which directly open into the cavity.

For producing the base element 1, as is shown in FIG. 2, plastic in a fluid or at least flowable form is injected through the injection channels 62 into the cavity which is formed by the injection mold 60 so that the cavity is completely filled up with plastic.

After the plastic has hardened, the base element 1, as shown in FIG. 3, can be demolded, i.e. removed from the injection mold 6.

The base element 1 has a front side 10 of planar design and a rear side 14, also of planar design, which extends parallel thereto. The front side 10 is bordered by an encompassing outer rim 11. At the sides, the front side 10 and the rear side 14 are interconnected by an encompassing side surface 15. The side surface 15 is in this case of curved design in such a way that in the cross-sectional view of FIG. 3 it extends from the rim 11 of the front side 10 via a quarter of an arc to the rear side 14. The base element 1 has a rear edge 19 at which the rear side 14 and the side surface 15 meet each other and include an angle of 90° there.

Extending through the base element 1 perpendicularly to the front side 10 and to the rear side 14 are a plurality of feed channels 16 which are arranged parallel to each other. The teed channels 16 are of sleeve-like, in particular cylindrical, design and each have a mouth which opens outward inside the front side 10, and a second mouth which opens outward inside the rear side 14.

For producing the component, the base element 1 is now inserted in another injection mold 7, as is shown in FIG. 4. The injection mold 7 is designed similar to the injection mold 6 but forms a slightly larger cavity and has a different arrangement of injection channels.

With the injection mold 7 closed, the base element 1 lies with its rear side 14 on a first, lower injection mold 71. A space 73, the design of which describes the shape of the cover layer 2 of the finished component 1, remains in the region between the front side 10 and the encompassing side surface 15 of the base element 1 on one side, and a second, upper injection mold 70 on the other side. The space 73 in this case is sealed toward the outside, at least with regard to the lacquer which is to be injected, in particular in that region where the two injection molds 70 and 71 butt against each other. The space 73 preferably has a height H of between 0.3 and 1.5 mm. The height H corresponds to the thickness D (FIG. 7) of the cover layer 2 which is to be produced.

Formed in the lower injection mold 71 are injection channels 72 which have a main channel and a plurality of end channels which branch off from this. The end channels open in each case directly into one of the feed channels 16 of the base element 1 which is inserted in the cavity of the injection mold 7. In order to facilitate removal of the component from the mold after the injecting molding, the end channels of the injection channels 72 are advantageously of conical design in each case, as shown in FIG. 4, with an opening angle which widens in the direction of the base element 1.

For producing the cover layer 2, a lacquer is now injected through the injection channels 72 and via the feed channels 16 into the space 73. In this case, the lacquer first of all completely floods over the front side 10 and then the encompassing side surface 15 of the base element 1 respectively. In this way, the base element 1, toward the side facing the observer, is completely coated with a cover layer 2 which is formed from the lacquer. If the finished component lies with its rear side 14 of planar design on an installation surface which is also of planar design, the base element 1, providing the cover layer 2 is opaque, is not visible at any point and from any direction of view. On account of injecting through the base element 1, the visible surface of the cover layer 2 has no irregularities, moreover. Use is preferably made of a lacquer which preferably at a point in time at which the lacquer begins to harden advantageously has a viscosity in the range of between 40 mPa*S and 500 mPa*s, measured at 65° C. With such viscosity values, good flowability of the lacquer is ensured. The viscosity is advantageously measured according to DIN 53019-1 Standard, September 2008 edition. The measuring of the viscosity is preferably carried out using a cone and plate rotational viscometer which features a fixed measuring cup and a rotating measuring body. For measuring the viscosity, for example the Rheomat R 180 viscometer made by the proRheo GmbH Company (Bahnhoffstrasse 40/2, 75382 Althenstett, Germany) can be used.

In preferred embodiments, use is made of a lacquer which after hardening forms a transparent or translucent cover layer 2. As a result, the base element 1 can be visible for the observer through the cover layer 2. The cover layer 2 preferably has a thickness D of between 0.3 and 1.5 mm.

As is apparent in FIG. 5, the base element 1 according to FIG. 5 has three feed channels 16. In the plan view of the base element 1, a first feed channel 16 has a triangular opening, a second feed channel 16 has a square opening, and a third feed channel 16 has an opening designed as a circle. So that the feed channels 16 formed in the base element 1 enable injection of the lacquer onto the base element 1 in such a way that the lacquer has not already hardened before it has reached all points of the base element 1, and also so that the component can be adequately, in particular homogenously, illuminated through the feed channels 16, the feed channels 16 should preferably have in each case an opening with a largest possible inner circle 191 which has a diameter d₁, d₂ and d₃ of between 0.2 and 5 mm, preferably between 1 and 5 mm, and the middle points M of the inner circles 191, moreover, should preferably be arranged with a mutual distance m₁, m₂ and m₃ of at least 0.4 mm from each other (see FIG. 5). In the case of more than three feed channels 16, the additional feed channels would be arranged and dimensioned accordingly.

In the case of the embodiment of a finished component shown in FIG. 6, a light conductor 80, which is accommodated in a housing 81, butts against the rear side 14 of the base element 1. The light conductor 80 butts in this case against the transparently or translucently formed lacquer particularly in the regions of the feed channels 16 in each case. The housing 81 is attached in an encompassing manner by means of an adhesive 82 in the region of the rear edge 19 of the base element 1. In addition to the light conductor 80, provision is also made inside the housing 81 for a lighting element 3, for example in the form of an LED, which is arranged at the side toward of the light conductor 80.

The light which is radiated from the lighting element 3 is coupled into the light conductor 80 and is directed through this toward the feed channels 16 and into these. Via the lacquer which is arranged in the feed channels 16, the light makes its way toward the front side 10 and also the side surface 15 of the base element 1 and therefore into the cover layer 2. On account of the transparency or translucency of the cover layer 2, the light is finally radiated in the direction of the observer and brings about a specific visual effect in this case. If the cover layer 2 has the properties of a diffuser, the light can be distributed evenly over the entire cover layer 2 and can be correspondingly radiated toward the observer.

After removal of the component from the injection mold 7, there are projections 20 protruding in each case on the rear side 14 of the base element 1 which are created on account of the injection channels 72 and can be removed. In the case of the embodiment of a component shown in FIG. 7, these projections 20 have not been removed, however, but serve as light conductors in order to transport the light radiated from the lighting elements 3 into the feed channels 16.

In the case of the embodiment shown in FIG. 8, the front side 10 of the base element 1 has a multiplicity of local elevations 12 and local recesses 13. Some of the feed channels 16 open inside a recess 13 and some open outward inside an elevation 12. The base element 1 is in this case altogether of essentially cuboid design and has four side surfaces 15 which are perpendicular to each other in each case. The front side 10 and the rear side 14 extend in each case perpendicularly to the side surfaces 15. The outer rim 11 of the front side 10 is formed in this case by an encompassing front edge at which the front side 10 and the corresponding side surface 15 each include an angle α of 90° (see FIG. 8).

One of the recesses 13 serves for accommodating an electronic unit 5. The electronic unit 5 forms an add-on part and has a printed circuit board 50 with a plurality of electronic components, which are not shown in the drawings. A power cable 51 serves for supplying the electronic unit 5 with electric power.

On the rear side 14 of the base element 1, a projecting fastening element 18 is provided which serves for the fastening of the finished component in the region of an installation surface.

During production of the component, the electronic unit 5, as is shown in FIG. 9, is inserted into the recess 13 which is correspondingly provided for it. Retaining elements 53, attached on the rear side of the printed circuit board 50, are in this case inserted into local recesses of the base element 1 which are formed correspondingly complementary to the retaining elements in order to fasten the electronic unit 5 on the base element 1. The power cable 51 in this case is guided through the base element 1 via one of the feed channels 16. A sealing plug 52, which is attached to the electronic unit 5, prevents the lacquer from being able to find its way into the feed channel 16.

The printed circuit board 50 has a through-opening 54 which comes to lie directly adjacent to one of the feed channels 16 so that this opens directly into the through-opening 54.

As the next step, a foil 4 is attached on the base element 1 in such a way that it completely covers the entire front side 10, the electronic unit 5 and all the side surfaces 15. The adhesion of the foil 4, which constitutes a further add-on part of the component, on the base element 1 can be achieved for example by means of electrostatic charging of the foil 4. The foil 4 in the present case can be a protective foil. The foil 4 can, however, instead of or in addition to the retaining elements 53 also be used in order to fasten the electronic unit 5 or another add-on part on the base element 1 before the injection molding.

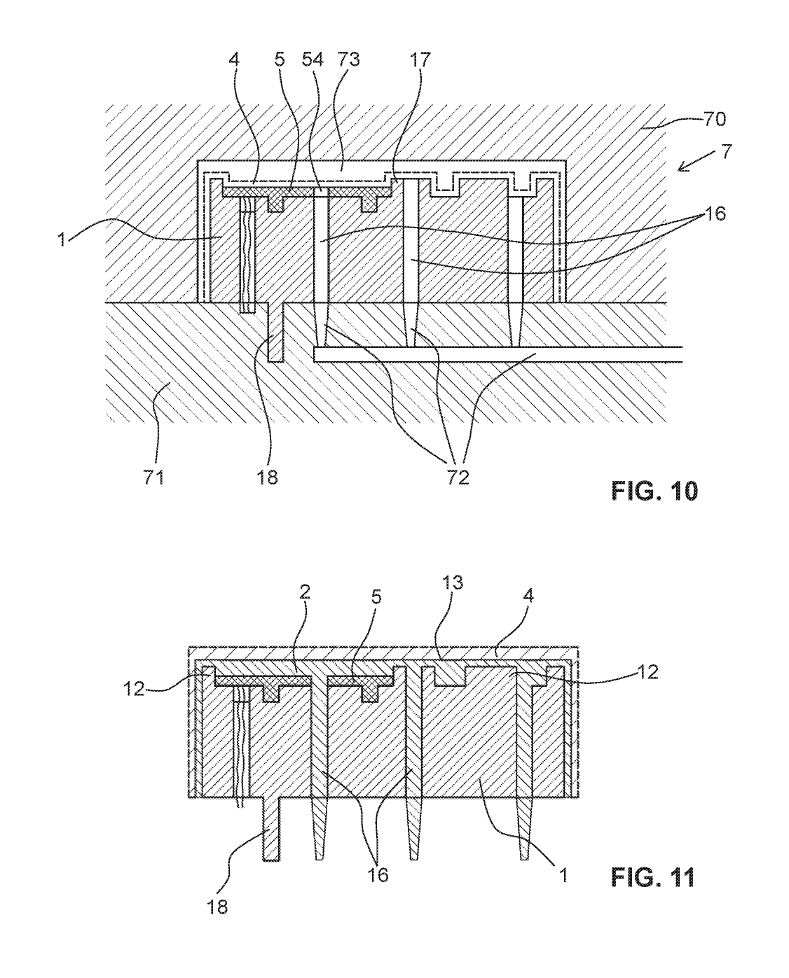

The injection molding of the lacquer onto the front side 10 of the base element 1 is shown in FIG. 10 and is carried out essentially in a similar way to the procedure already explained with reference to FIG. 4. In contrast to the method of FIG. 4, the lacquer in this case is not only directed through the feed channels 16 toward the front side 10, however, but additionally also through the printed circuit board 50 of the electronic unit 5. The lacquer, after passing through the through-opening 54, consequently flows directly over the electronic unit 5, as a result of which any lateral forces acting upon the electronic unit 5 are substantially reduced. The injecting of the lacquer through the through-opening 54 can prevent displacement of the electronic unit 5 in particular even in cases in which the electronic unit 5 does not butt against, or only partially butts against, a local elevation 12.

In order to protect the electronic unit 5 from the pressure of the inflowing lacquer and/or in order to avoid a flow under the electronic unit 5, provision is made adjacent to this for a baffle wall 17 which is formed by one of the elevations 12. On account of the baffle wall 17, the lacquer makes it way to the electronic unit 5 from above in any case during the injection molding.

During the injection molding in the injection mold 7 shown in FIG. 10, the foil 4 becomes detached from the base element 1 and from the electronic unit 5 on account of the injection pressure and is pressed against the inner wall of the upper, first injection mold 70. In this case, the foil 4 is connected to the lacquer so that it adheres to the finished cover layer 2. This is shown in FIG. 11.

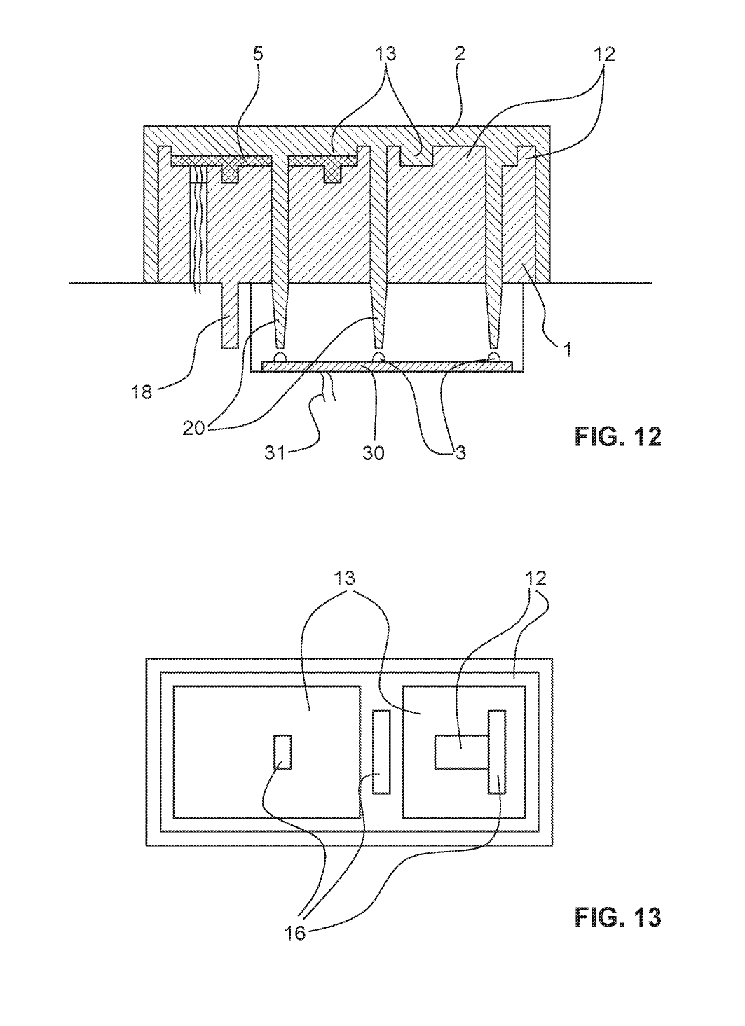

Shown in FIG. 12 is how the finished component according to FIG. 11 is installed by means of the fastening element 18. After installation, the foil 4 is pulled off from the cover layer 2 and disposed of. The projections 20 protrude in this case into a recess, provided inside an installation surface, in which lighting elements 3 are also arranged. Via the projections 20 and through the hardened lacquer which is arranged in the feed channels 16, the light radiated by the lighting elements 3 makes its way into the cover layer 2 and from this to the observer. The lighting elements 2 are attached on a common printed circuit board 30 which is supplied with electric power by means of a power cable 31.

The elevations 12 and recesses 13 which are formed on the front side 10 of the base element 1 can form a logo and/or a symbol which can be seen in the finished component by the observer.

The invention is naturally not limited to the previously described embodiments, and a large number of variations are possible. In this respect, the feed channels for example do not necessarily have to open outward inside the rear side of the base element but can also do this for example inside the side surfaces. Moreover, the feed channels can have a different shape as shown for example in the Figures. The openings according to FIG. 5 have a triangular shape, a square shape and are also formed in the shape of circle. Naturally, these openings can have a shape which is different to those shown in FIG. 5. Any shapes for the openings are possible. In the case of the add-on part, it does not necessarily have to be an electronic unit for a foil but can be any other part. The add-on part can for example also be formed by a layer or a coating. The production of the base element does not necessarily have to be carried out in an injection molding process but can take place in any other way. The base element can also have an optional shape. A large number of further variations are possible.

LIST OF REFERENCE NUMERALS

| | |
|---|---|
| 1 | Base element |
| 10 | Front side |
| 11 | Rim |
| 12 | Elevation |
| 13 | Recess |
| 14 | Rear side |
| 15 | Side surface |
| 16 | Feed channel |
| 17 | Baffle wall |
| 18 | Fastening element |
| 19 | Rear edge |
| 191 | Inner circle |
| 2 | Cover layer |
| 20 | Projection |
| 3 | Lighting element |
| 30 | Printed circuit board |
| 31 | Power cable |
| 4 | Foil |
| 5 | Electronic unit |
| 50 | Printed circuit board |
| 51 | Power cable |
| 52 | Sealing plug |
| 53 | Retaining element |
| 54 | Through-opening |
| 6 | Injection mold |
| 60 | First injection mold |
| 61 | Second injection mold |
| 62 | Injection channels |
| 63 | Projections |
| 7 | Injection mold |
| 70 | Upper injection mold |
| 71 | Lower injection mold |
| 72 | Injection channels |
| 73 | Space |
| 80 | Light conductor |
| 81 | Housing |
| 82 | Adhesive |
| d₁, d₂, d₃ | Diameter |
| m₁, m₂, m₃ | Distance |
| α | Angle |
| D | Thickness |
| H | Height |
| M | Center point |

1. A method for producing a component with a base element, which has a front side front side delimited by an outer rim, a rear side and one or more side surfaces which interconnect the front side and the rear side, and with a cover layer, formed from a lacquer, which is injection molded on the base element, wherein the lacquer, during the injection molding, is directed through one or more feed channels which extend continuously through the base element toward the front side and/or toward one or more of the side surfaces, and wherein the lacquer, during the injection molding, is flooded onto at least a part of the side surfaces.

2. The method as claimed in claim 1, wherein the lacquer, during the injection molding, is flooded over and beyond the outer rim of the front side.

3. The method as claimed in claim 1, wherein the lacquer has a viscosity in the range of between 40 mPa*s and 500 mPa*s, measured at 65° C.

4. The method as claimed in claim 1, wherein the base element has at least one rear edge at which the rear side and the side surface, or side surfaces, meet each other, and wherein the lacquer, during the injection molding, floods over a part of the side surfaces up to this rear edge so that the cover layer completely covers the corresponding part of the side surfaces from the front side up to the rear edge.

5. The method as claimed in claim 1, wherein the cover layer is at least partially translucent.

6. The method as claimed in claim 5, wherein at least one lighting element is provided in order to illuminate the component through the feed channel(s).

7. The method as claimed in claim 5, wherein the cover layer forms a diffuser.

8. The method as claimed in claim 5, wherein a plurality of feed channels is provided which each have an opening, wherein the largest possible inner circle of a respective opening has a diameter of between 0.2 and 5 mm, and wherein the center points of the inner circles have a mutual distance of at least 0.4 mm.

9. The method as claimed in claim 5, wherein during the injection molding a projection, which in each case protrudes relative to the rear side of the base element, is formed in the region(s) of the feed channel(s), and wherein this/these projection(s) serves/serve as a light conductor in the component in order to conduct light to the front side and/or side surface.

10. The method as claimed in claim 1, wherein the component also has an add-on part which covers at least a part of the front side and/or side surface, and which during the injection molding is in contact with the lacquer and consequently is connected to the cover layer.

11. The method as claimed in claim 10, wherein the add-on part is arranged between the base element and the cover layer.

12. The method as claimed in claim 11, wherein the base element has at least one forward projecting baffle wall in the region of its front side in order to protect the add-on part during the injection molding.

13. The method as claimed in claim 11, wherein the feed channel(s) extends/extend through the add-on part so that the lacquer, during the injection molding, is directed through the add-on part toward the front side and/or side surface.

14. The method as claimed in claim 10, wherein the add-on part is a foil or an electronic unit.

15. The method as claimed in claim 10, wherein the cover layer is arranged between the base element and the add-on part.

16. The method as claimed in claim 15, wherein the add-on part is a foil.

17. The method as claimed in claim 1, wherein the front side of the base element has local elevations and/or recesses.

18. The method as claimed in claim 1, wherein the component is intended for the automobile industry.

19. A component having a base element with a front side, a rear side and with one or more side surfaces which interconnect the front side and the rear side, and a cover layer which covers at least a part of the side surfaces and is made of a lacquer injection molded on the base element, wherein the base element has one or more feed channels which extend continuously through the base element toward the front side and/or toward one or more of the side surfaces, and wherein the lacquer extends through the one or more feed channels.
